(19) United States
(12) Patent Application Publication
(10) Pub. No.: US 2017/0293868 A1
(43) Pub. Date: Oct. 12, 2017

(54) FLIGHT REBOOKING

(71) Applicant: Aviel SIMAN-TOV, Herzeliya (IL)

(72) Inventors: Aviel SIMAN-TOV, Herzeliya (IL); Ami Ze'ev GOLDENBERG, Ramat-Gan (IL); Gili Trudi LICHTMAN, Kfar-Shemaryahu (IL); Uri LEVINE, Tel-Aviv (IL)

(21) Appl. No.: 15/513,559

(22) PCT Filed: Sep. 22, 2015
(86) PCT No.: PCT/IL2015/050969

§ 371 Date: Mar. 23, 2017

Related U.S. Application Data
(60) Provisional application No. 62/053,934, filed on Sep. 23, 2014.
(60) Provisional application No. 62/053,919, filed on Sep. 23, 2014.

(51) Int. Cl. G06Q 10/02; G06Q 50/14

(52) U.S. Cl. CPC G06Q 10/025; G06Q 50/14

(57) ABSTRACT

A method of managing a rebooking of a purchased flight ticket by iteratively querying network resources using software modules for data used for matching an alternative flight ticket. The method comprises designating a purchased flight ticket of a flight comprising purchased flight legs, gathering purchased flight data by identifying values each of one of flight leg parameters of each flight leg, in each of matching iterations, querying at least one flight leg database for a match indicative of an alternative flight ticket based on the purchased flight data, in each iteration, when the match is found, estimating a rebooking advisability rank while taking into account a cancellation fee of one or more of the purchased flight legs, and when the rebooking advisability rank is above a threshold forwarding to the user a notification about the alternative flight ticket.

### BACKGROUND

The present invention, in some embodiments thereof, relates to an interactive computer system, such as an interactive Web site or application and, more specifically, but not exclusively, to an interactive computer system for rebooking flight tickets.

With the rapid growth of societies, it has become popular for people to take business trips or leisure journeys to different countries. In order to provide a convenient service for passengers to purchase flight tickets, the passengers can purchase flight tickets not only directly from the airlines or the travel agency counters, but also via the Internet from other sales points.

There are known in the art interactive travel services on the Internet that allow consumers to purchase airline travel tickets on-line. Typically, such services require the consumer to input to the travel service server information regarding the origination and destination cities, dates and approximate times of departure, and optionally a preferred carrier. The travel service then carries out a search on a commercial airline reservation system such as Amadeus or Sabre.

The service then displays to the user a list of flights for which seats are listed as being available at that time, together with the fares for such flights. The user then has the option of purchasing a selected flight from the list, either by transmitting to the service credit card information over the Internet, by calling a telephone number or possibly by transmitting payment information by email or other communication means.

### SUMMARY

According to an aspect of some embodiments of the present invention there is provided a system of managing a rebooking of a purchased flight ticket by iteratively querying a plurality of network resources using a plurality of software modules for data used for matching an alternative flight ticket. The system comprises a network interface for receiving a user input of a user via a network, a program store storing code, and a processor coupled to the network interface and the program store for executing the stored code, the code comprising: code instructions for designating, according to the user input, a purchased flight ticket of a flight comprising a plurality of purchased flight legs, code instructions for gathering purchased flight data by identifying, for each one of the plurality of purchased flight legs, a plurality of values each of one of a plurality of flight leg parameters comprising at least a price, a flight class, departure time, and arrival time, code instructions for querying, in each of a plurality of matching iterations, at least one flight leg database for a match indicative of an alternative flight ticket based on the purchased flight data, code instructions for estimating in each of a plurality of matching iterations, when the match is found, a rebooking advisability score while taking into account a cancellation fee of at least one of the plurality of purchased flight legs, and code instructions for forwarding to the user a notification about the alternative flight ticket when the rebooking advisability score is above a threshold.

Optionally, the notification is forwarded in one of the plurality of matching iterations only when respective the alternative flight ticket is estimated to be better than another alternative flight ticket associated with a previously sent notification in a previous matching iteration of the plurality of matching iterations.

Optionally, the processor executes additional code instructions in the stored code, the additional code instructions comprising: code instructions for estimating a current probability of having a future alternative flight ticket which is better than the alternative flight ticket. The notification is forwarded when the current probability complies with a threshold.

Optionally, the processor executes additional code instructions in the stored code, the additional code instructions comprising: code instructions for estimating a probability the user will cancel the purchased flight ticket for an alternative flight ticket according to an analysis of a member of a group consisting of the cancellation fee, the price, a number of the plurality of flight legs, historical rebooking data of a plurality of different users, a ranking of a fare basis within the flight, an airline rating of the flight at least one seasonality trend. The at least one flight leg database is queried when the probability is higher than a threshold.

Optionally, the processor executes additional code instructions in the stored code, the additional code instructions comprising: code instructions receiving from the user a response to the notification via the network, the response comprises a rebooking indication, code instructions for booking the alternative flight ticket, code instructions for canceling the purchased flight ticket when the alternative flight ticket is booked, code instructions for ticketing alternative flight ticket.

More optionally, the processor executes additional code instructions in the stored code, the additional code instructions comprising:

selecting at least one communication instructions object that comprises instructions for communicating with an online ticket provider service of flight tickets that offers for sale the alternative flight ticket, the at least one communication instructions object is selected from a plurality of communication instructions objects each comprising different instructions for communicating with a different online ticket provider service. The booking, the canceling, and the ticketing are done using the communication instructions object.

Optionally, the processor executes additional code instructions in the stored code, the additional code instructions comprising: code instructions estimating a rank of the purchased flight ticket according to an analysis of the plurality of values of each of the plurality of flight leg parameters. The flight leg database(s) are queried when the rank is higher than a threshold.

Optionally, the processor executes additional code instructions in the stored code, the additional code instructions comprising: code instructions estimating a rank of the alternative flight ticket according to an analysis of values of each of the plurality of flight leg parameters of the alternative flight ticket. The notification is sent to the user when the rank is higher than a threshold.

More optionally, the rank is calculated based on a suitability of the alternative flight ticket to a user profile of the user.

More optionally, the plurality of values comprises at least some members of a group consisting of an aircraft model, an aircraft, an aircraft version, an airline, a seat type, amenities associated with the flight ticket, a meal evaluation score or type, a luggage cost, a cabin class, a flight duration, a layover time, a number of connections, a mileage point accrual, fare rules, a cancellation fee, a change fee, and airport ranks.

Optionally, the notification is sent to a client application executed on a client terminal associated with the user.

Optionally, the notification is an email or an SMS sent to the user.

Optionally, the processor executes additional code instructions in the stored code, the additional code instructions comprising: acquiring at least some of the plurality of values from a Global Distribution System by using at least some others of the plurality of values as search query terms.

According to an aspect of some embodiments of the present invention there is a method of managing a rebooking of a purchased flight ticket by iteratively querying a plurality of network resources using a plurality of software modules for data used for matching an alternative flight ticket. The method comprises designating, according to user input, a purchased flight ticket of a flight comprising a plurality of purchased flight legs, gathering purchased flight data by identifying, for each one of the plurality of purchased flight legs, a plurality of values each of one of a plurality of flight leg parameters comprising at least a price, a flight class, departure time, and arrival time, in each of a plurality of matching iterations, querying at least one flight leg database for a match indicative of an alternative flight ticket based on the purchased flight data, in each of a plurality of matching iterations, when the match is found, estimating a rebooking advisability score while taking into account a cancellation fee of at least one of the plurality of purchased flight legs, and when the rebooking advisability score is above a threshold forwarding to the user a notification about the alternative flight ticket.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of managing a swap between a purchased flight ticket and an offered for sale flight ticket based on real time monitoring of one or more network resources using one or more sensor modules, according to some embodiments of the present invention;

FIG. 2 is a schematic illustration of a system for implementing a method of managing a swap between a purchased flight ticket and an offered for sale flight ticket, for example by implementing the method depicted in FIG. 1, according to some embodiments of the present invention;

FIG. 3 is a process for continuously or iteratively collecting data, according to some embodiments of the present invention;

FIG. 4 is a process for calculating a rebooking advisability rank, according to some embodiments of the present invention;

FIG. 5 is a flowchart of an iterative process of sending sequential notifications, each based on different parameters, according to some embodiments of the present invention;

FIG. 6 is a probability evaluation process, according to some embodiments of the present invention;

FIG. 7 is another probability evaluation process, according to some embodiments of the present invention;

FIG. 8 is a flowchart of a rebooking process according to some embodiments of the present invention; and

FIG. 9 is a flowchart of a cancellation process, according to some embodiments of the present application.

### DETAILED DESCRIPTION

The present invention, in some embodiments thereof, relates to an interactive computer systems, such as an interactive Web site or application and, more specifically, but not exclusively, to an interactive computer system for rebooking flight tickets.

According to some embodiments of the present invention, there are provided methods and systems for managing a discovery process wherein alternative or identical flight tickets to a purchased flight ticket are identified based on data acquired iteratively from one or more network sources. The methods and systems provide a user with a simple user experience for rebooking a purchased flight ticket with an alternative or identical, but cheaper, flight ticket that provides more value to the user at no or low cost, optionally in an automatic or semi-automatic manner.

In use, the user designates the purchased flight ticket by providing simple unique identifiers or by uploading the details of purchased flight ticket. Values of flight legs are identified and used for generating a flight ticket query iteratively submitted to one or more network sources. As described below, queries may be sent in a frequency optimized to reduce system operation cost and/or for improving computational efficiency. Responses to the flight ticket query are analyzed to identify alternative and identical flight tickets having similar or better flight leg parameters. The alternative flight tickets may be filtered, optionally based on the profile of the user or based on historical data of similar users, inter alia to avoid false positive identification or offering tickets that have no value to the user. The user may now notified about the found alternative flight tickets, optionally after a decision to notify the user is automatically taken based on a progressive notification flow and/or based on the user responsiveness to previous notifications. In such a manner, the user is not bothered with notifications when his behavior indicates that he does not want to purchase certain alternative flight tickets.

According to some embodiments of the present invention, when a user indicates that he is interested in rebooking, a process of synchronizing the cancellation of the purchased flight ticket with the booking and ticketing of a suitable alternative flight ticket is executed. This process may be triggered and completed by a single click or touch selection.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

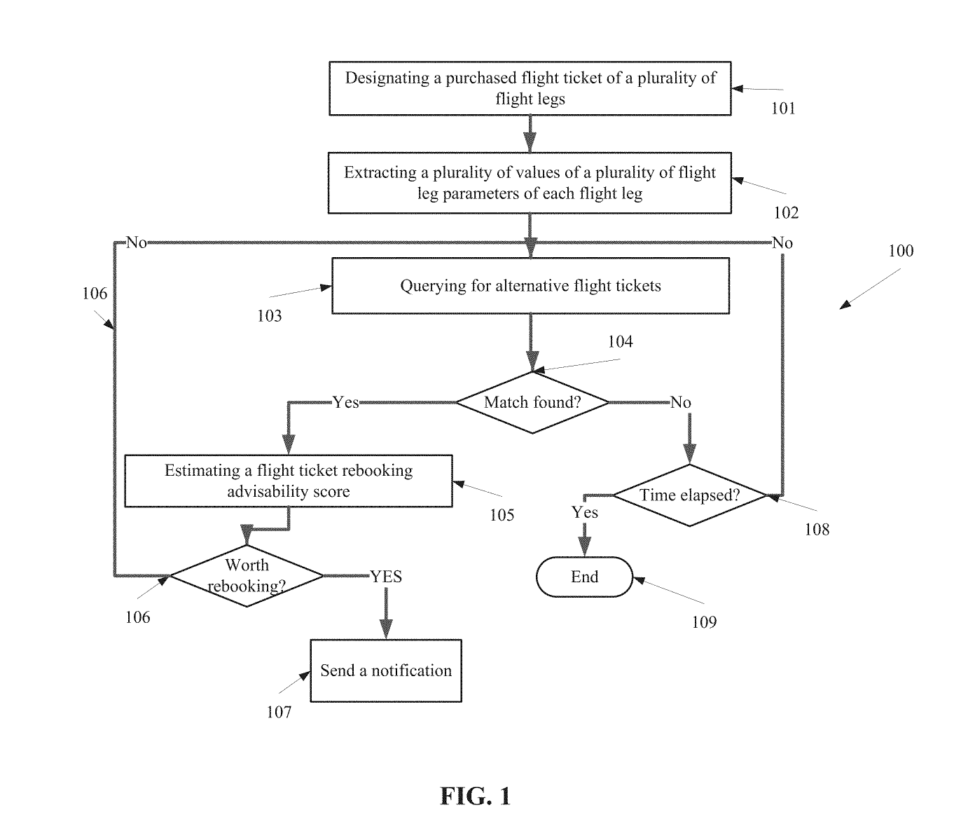

Reference is now made to FIG. 1, which is a flowchart of a method 100 of flight discovery process wherein an automatic or semi-automatic flight ticket rebooking is managed according to some embodiments of the present invention. As used herein a rebooking process is a process wherein a purchased flight ticket is cancelled and an offered for sale flight ticket is automatically booked and ticketed based on continuous or iterative searching in one or more network resources, according to some embodiments of the present invention.

The method 100 allows a user, for example a user who browses a designated webpage or uses an application executed on a client terminal to designate a purchased flight ticket for rebooking. The method 100 involves continuous or iterative monitoring of flight legs available for purchase at one or more network sources for identifying alternative flight ticket(s), including the same flight ticket in a lower price. For brevity, referred to herein an alternative flight ticket, having flight legs with one or more flight leg parameter values which are relatively better, for instance lower price, a higher class, a better seat location, and/or the like. The method 100 provides a technical solution to the problem of post purchase flight ticket value optimization based on a real time analysis of a plurality of offered for sale flight legs. The method may be implemented using a plurality of software modules each managed to sample data from a different network resource offering for sale flights and flight legs or to query a network resource for a match with a set of values representing the purchased flight ticket. For brevity, a purchased flight ticket is for a flight leg or for an air journey (itinerary) which may involve change of aircraft and several flight legs from the starting point to the final destination. A flight leg is a segment of a flight optionally involving a stopover, change of aircraft, or change of airline. A stopover is a deliberate and planned interruption of a journey for 24 or more hours. A stopover shorter than 24 hours is generally called ‘via’ or ‘connection’ as used herein network resources is any database or service that provides flight leg data. A client terminal may be any device that can be used by a user to designate a flight ticket, for instance by inputting a flight identifier such as a combination of a PNR (Passenger Name Record) number and a family name of a traveler and/or uploading the details of a flight itinerary, for instance uploading an itinerary confirmation email (e-ticket) via an e-mail and/or uploading user interface (UI). The client terminal may be a Smartphone, a tablet, a laptop, a desktop and/or the like. An application may be a browser executed widget, an Application store installed application, a desktop application and/or any executable that is running on processor(s). When a combination of a PNR number and a family name is inputted, a Global Distribution System (GDS) or another booking system may be queried by a search platform of the system for acquiring the values of the respective flight legs. The search platform optionally includes one or more communication instructions objects such as code scripts including APIs for querying one or more GDSs and/or other network resources. When an email of a flight is uploaded a parser may be used to parse the email or file in order to retrieve the values of the respective flight legs. Optionally, information missing after the parsing or the acquisition of a flight ticket via a GDS is acquired by querying network sources, for instance an API of a respective airline and/or an airport website. The uploading and the acquisition of the missing parts may be done by a designated module.

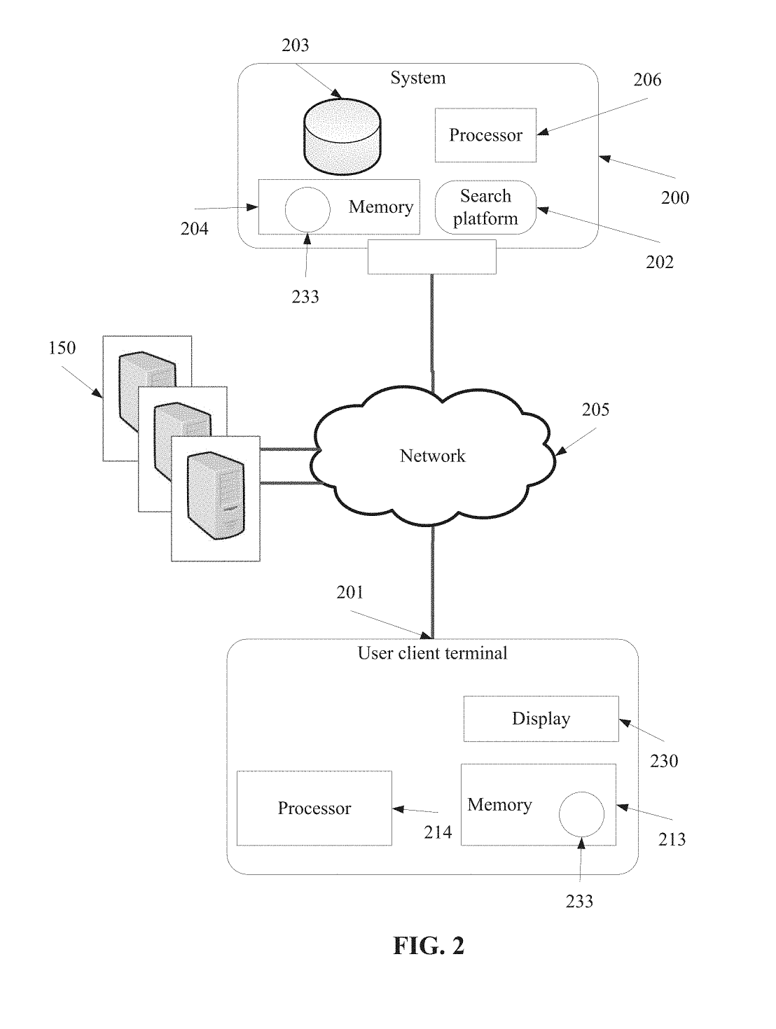

Reference is also made to FIG. 2 which is a schematic illustration of system 200 for implementing a method of managing a swap between a purchased flight ticket and an offered for sale flight ticket based on real time monitoring of one or more network resources, for example by implementing the method depicted in FIG. 1, according to some embodiments of the present invention. The schematic illustration depicts the system 200 and a client terminal 201 rendering a graphical user interface (GUI) for designating a flight, and one or more network resources 150, according to some embodiments of the present invention. The system 200 may be implemented by one or more network nodes which are connected to a network 205 such as the internet, for example one or more servers, virtual machines (VMs) and/or the like. The GUI is optionally an interactive user interface rendered or otherwise displayed on a screen 230 of the client terminal, for instance by a browser or a client application 233 executed on the client terminal. The client terminal 201 includes processor(s) 214 and a memory unit 213, namely a program store, for supporting the presentation of the GUI, for example by executing a browser, an add-on, and/or an application loading and rendering the GUI and identifies the user selections. The GUI optionally includes a field or another element for receiving from a user a flight definition and optionally for presenting notifications.

The system 200 includes one or more processors 206 and a program store 204, also referred to as a memory, for storing instructions for executing a flight ticket rebooking process and a flight tickets discovery process and the search platform 202 which may be also stored memory and includes instructions for communicating with the one or more network resources 150. Code for executing these processes may be referred to herein as modules. The instructions for executing these processes may be divided between a number of units, for example different servers of the system 200 and/or between the system 200 and the client terminal 201. The system 200 may include or be connected to one or more databases 203, optionally local, which store data, for example flight leg records, subscriber profiles (e.g. an outcome of a user registration process) or purchased flight ticket records or links to purchased flight tickets for allowing continuous search for alternative flight tickets.

With reference to FIG. 1 again, as shown at 101, a purchased flight ticket of a flight comprising a plurality of purchased flight legs is designated according to a user input, for instance using the above described GUI and/or by receiving an email or an e-ticket file from the user. The designated purchased flight ticket is optionally documented in the database 203.

As shown at 102, for each one of the purchased flight legs of the flight of the purchased flight ticket, values of a plurality of flight leg parameters are extracted or otherwise identified as described below. The values include at least a price, a flight cabin class, a departure time, and an arrival time. Other values may be an aircraft model and version, an airline, a seat type, amenities associated with the flight ticket, meal evaluation score or type, luggage check-in costs, fare class, flight duration, layover times, number of connections, mileage point accrual, Fare rules, Cancellation fee, Change fee, Per leg fee, Per leg Departure/arrival times, and/or Airport ranks. Some of the values may be extracted from the purchased flight ticket and other may be identified by using the values of the purchased flight ticket to build a search query and/or queries which are inputted to suitable network resources and/or to a flight leg database that documents information about different flights, for instance indexed based on a flight leg number.

The values of the purchased flight ticket are optionally stored in a purchased flight record, for example as a feature vector, a matrix, and/or any other dataset.

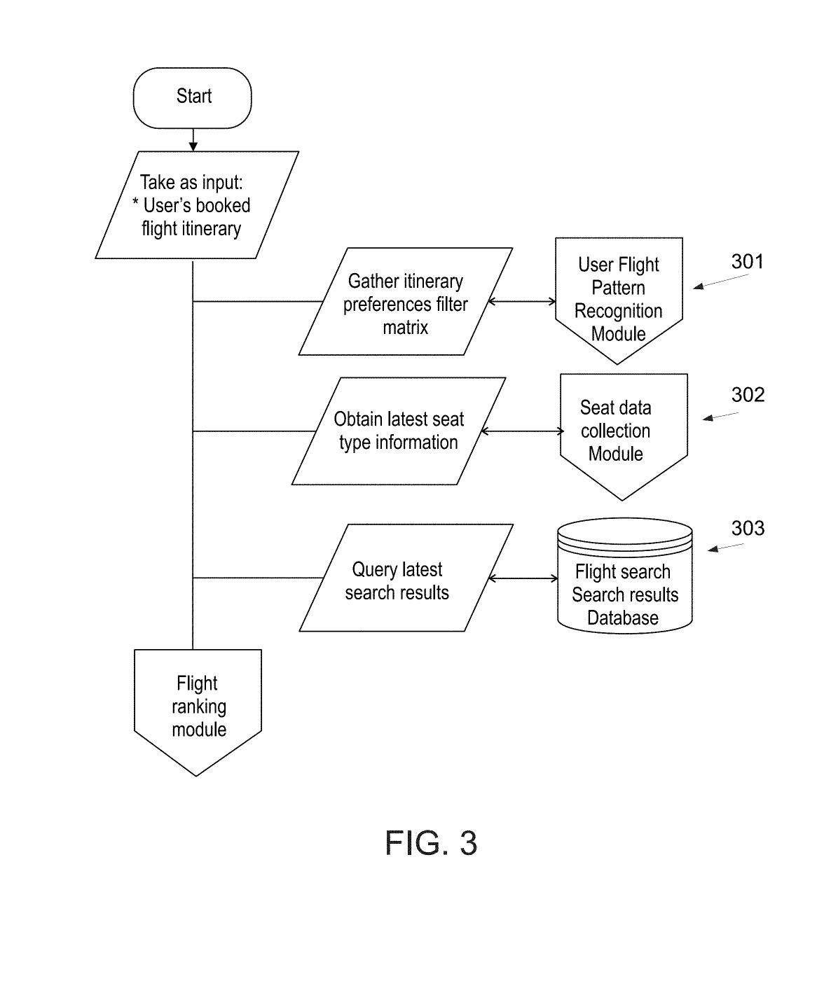

Optionally, a purchased flight record is created by acquiring the values of the respective flight legs and additional data. For example, past flight activity of the respective traveler (e.g. the traveler to which the purchased ticket belongs). The past flight activity may be extracted from the user profile of the traveler designated in the purchased flight ticket. This past flight activity, referred to also as historical data, may also be combined with information about similar users who match the user profile, for instance as documented in database 203. The matching of the traveler with similar users (travelers) may be done by matching user profiles. As used herein, a user means a user who designates a flight ticket and/or a subscriber of the system 202 and a traveler, which may be the user, is the person to which the purchased flight ticket is indented to. As depicted in FIG. 3, the historical data may be gathered by a user flight pattern recognition module 301. A similar user may be a user with past flights similar to the purchased flight ticket, a user with similar behavior patterns, for example a user which has similar historical data, and/or users of similar demographic characteristics (e.g. age, location, gender etc.).

Using this data, a pattern recognition module may build a preferences profile for the traveler itinerary. The preferences profile may be represented in a matrix of preferences and may be added or associated with the purchased flight record.

Optionally, an aggregate preference matrix is generated from an analysis of the historical data, for instance by a scoring of latest historical flight leg data records based on date and similarity. Similarity may be estimated by matching values of flight leg parameters of flight legs of the purchased ticket with values of flight leg parameters of flight legs documented in historical data of users.

As depicted in FIG. 3, a seat collection module 302 may be executed for continuously or iteratively collecting seat type information per aircraft per airline from one or more of the network resources 150. This information is saved to a database, for instance 203, for future reference by other modules. Information is collected from airline seat information aggregators, including but not exclusive to SeatGuru.com and SeatExpert.com. The information gathered is as detailed as possible, including seat width, seat angle, availability of Wi-Fi, availability of power outlets, entertainment system level or rank etc. In use, respective values of a purchased ticket record data are updated based on the data gathered by the seat collection module 302, optionally by matching a seat number with the stored seat data. As shown at 303, the above, together with information from network resources for searching for a match between the values of the flight legs of the flight in the purchased flight ticket and values of alternative flight legs that can be combined to a flight may be used for ranking alternative flight tickets.

As shown at 103, in each of one or more matching iterations, one or more network resources 150 such as flight leg search engines are queried by the system 202, for instance an executed flight tickets discovery process, for finding one or more matches (for brevity referred to herein a match) between respective plurality of values of each of the plurality of purchased flight legs (and optionally additional data as depicted in FIG. 3) and respective values of members of a subgroup of a plurality of offered for sale flight legs. Finding a match is indicative of a potential alternative flight ticket selected based on the subgroup. The matching may involve filtering results based on suitability, for example departure and/or arrival in a certain time range, a cost within a range, a seat class matching and/or the like. The matching takes into account the change/cancellation cost of the purchased flight ticket.

Optionally, each of the purchased flight tickets and the matched alternative flight tickets is ranked, for instance using a ranking function that takes into account the values of the respective flight leg parameters and optionally a set of weights, each given to a different flight leg parameter. The ranking allows determining whether an alternative flight ticket is better, equal and/or not as good as the purchased flight ticket. Optionally the higher the rank the better is the ranked ticket. Optionally the lower the rank the better is the ranked ticket.

As shown at 104, 105, after one or more matches are found and optionally after the filtering, a rebooking advisability rank for each match is estimated (e.g. a score or a value in a scale), for instance by an execution of the flight ticket rebooking process or the flight tickets discovery process. The calculation of the rebooking advisability rank optionally takes into account a cancellation and/or change fee of one or more of the purchased flight legs and optionally based on the rank of the purchased flight ticket and the respective alternative flight ticket. The calculation of the rebooking advisability rank may be based on the outputs of a flight ranking module as depicted in FIG. 3 and described above.

For example, as depicted in FIG. 3, the flight ranking module 303 may be executed for continuously or iteratively collecting flight search results which are matched with the plurality of values of each of the plurality of purchased flight legs. The flight search results are filtered based on the preferences matrix or aggregate preferences matrix described above. Any remaining results may be ranked and given a comfort score, optionally according to user's preferences and/or seat information and/or plurality of other parameters related to the flight(s). The ranking may be done by using weights where each flight leg parameter is given a weight. Weights may be adapted dynamically, for instance by a system operator and/or a statistical classifier. Eventually some or all of the flight search results is given a comfort score, namely a sum of all parameter scores, scaled by a ladder of the system operator's choosing (e.g. between 1 and 10).

As shown at 106 and 107, when the rebooking advisability rank of a certain alternative flight ticket is above a threshold, either static or dynamic, a notification detailing one or more offers to purchase the alternative flight ticket identified in 106 is sent, for instance by presenting an application notification, sending an electronic mail, sending an instant message (IM) message and/or a short message service (SMS).

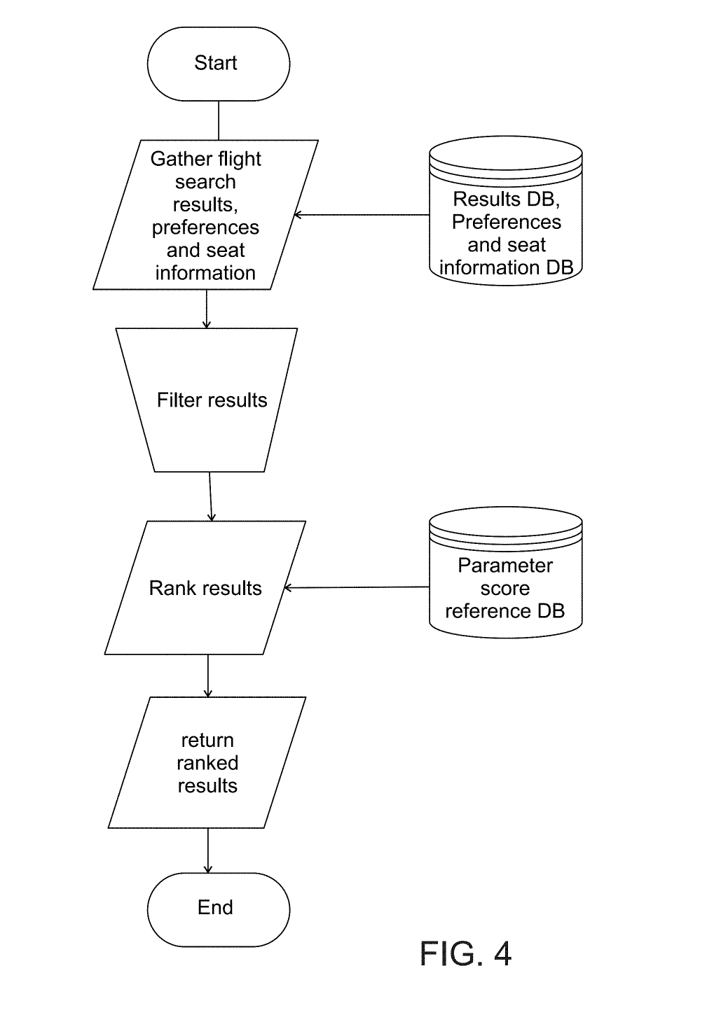

In each iteration, the rebooking advisability rank, also referred to as a rank, is calculated for each of a plurality of matches, optionally after filtering and based on data from a parameter score reference database (DB), for example data indicative of the importance of each value, for instance as depicted in FIG. 4.

As shown at 108, 109, the flight discovery process for recommending and/or managing rebooking as depicted in FIG. 1 ends when the time left to the departure of the flight documented in the last purchased ticket is less than a configurable minimum.

According to some embodiments of the present invention, a progressive notification process (also referred to herein as a progressive notification flow) is executed for sending notifications during a flight discovery process wherein a plurality of alternative flight tickets are identified sequentially. The process iteratively queries for a match for values of flight legs of a purchased flight ticket as described above and when a match is found and the respective rebooking advisability rank is above a threshold, a notification is sent to the user who submitted the respective purchased flight ticket. As used herein iteratively includes performing a number of times per hour, performing a number of times per day, performing a number of times per week, performing a number of times per month and/or in intermediate frequency. The frequency of querying may be changed over time, for example according to the period left for the departure. Optionally, the threshold is a dynamic threshold reduced or otherwise softens with time, for example when less time is left for the departure time and/or dynamically adapted based on an estimation of calculating the probability of finding better alternative flight tickets according to values of flight parameter legs of the purchased flight ticket. For brevity, a better flight ticket is a flight ticket having a higher rank than another flight ticket or having at least one value of at least one of the flight parameter legs better than the respective value of another flight ticket while the other values are at least as good. Better may be a better price, a better seat, a better timing, a user preferred airline, a better class, better estimated service and/or terms and/or the like.

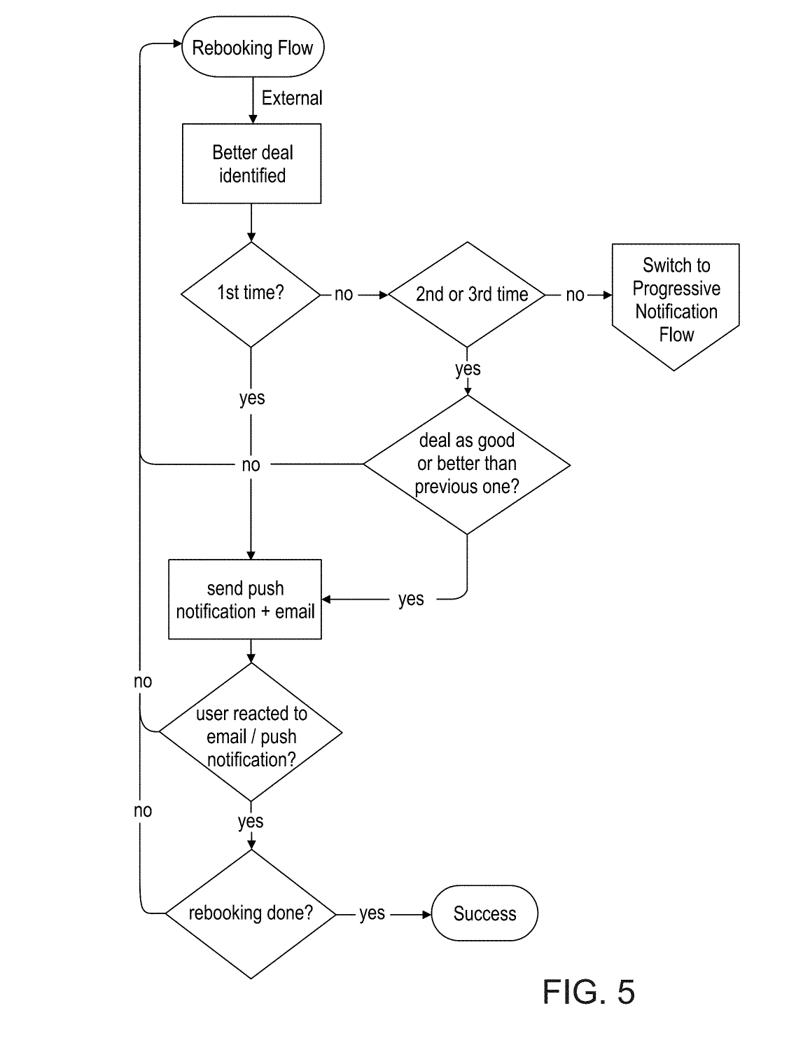

According to some embodiments of the present invention, a state machine like process is used for determining whether to send a notification about a match. In such an embodiment, the number of previously sent notifications may be taken into account, ensuring that when a user ignores a notification or rejects an offer in the notification, a new notification is sent only when an alternative flight ticket better than a previously offered alternative flight ticket is found. This mechanism allows avoiding bothering the user with notifications when his behavior indicates that he does not want to purchase certain alternative flight tickets. For instance, FIG. 5 is a flowchart of an iterative process of sending a first notification based on any match, a second and/or third notification only for an alternative flight ticket better than the previously offered alternative flight ticket is found and any additional notification based on the above progressive notification process. Reference is now made to a description of a time dependent notification transmission flow where X denotes a number of notifications sent so far, Y denotes a number of notifications allowed by the user so far, K denotes a number of alerts before considering progressive schema (in FIG. 5 K=3), and Z denotes a number of progressive notifications allowed, and D denotes a number of lookup days.

During a process that follows a time dependent notification transmission flow, no more than X notifications are sent within D days (bound by Y allowed notifications). Each of these notifications includes an offer to an alternative flight ticket, optionally selected based on a match with or without filtering as described above. After the first K notifications, no more than Z notifications are sent when none of the first K notification are accepted by the receiving user and then a progressive notification process is activated, for instance as described above. In other words, after sending Y notifications, K notifications are sent only when there is an improvement to the rebooking advisability rank above a threshold, for instance when a reduction of at least $100 in the price is detected. The next notification will be sent only when there is another improvement to the rebooking advisability rank above a threshold, for example a yet another reduction of $100 in the cost of the flight.

Additionally or alternatively, the system 200 may send notification(s) based on a forecast of future availability of alternative flight tickets which are better than the purchased flight ticket and better than currently available alternative flight tickets.

Additionally or alternatively, the system 200 may query network resources in a frequency that is determined based on a probability (also referred to as a chance) that the user will actually conduct rebooking, for instance based on an estimation that alternative flight tickets which are actually better than the purchased flight ticket exist and/or based on an estimation of the behavior of the user in response to previous notifications. The type of the queried network resources may also be determined based on this probability. In such a manner, expensive to use network resources may be addressed only when the probability is high.

In such embodiments access to network resources may be reduced to optimize the operation cost of the system 200. For instance the frequency of sending requests to network sources 150 the purchased flight ticket is determined based on the probability of finding an alternative flight ticket. Optionally, the estimation is represented by a score that may be presented to a user, for instance by a client module installed on the client device, in a designated webpage and/or sent in a notification to the user. This allows the user to understand in advance what the probability of finding an alternative flight ticket is, thus setting expectations, creating trust and immediate value for the user. The score may be calculated according to the rank of the purchased flight ticket, for instance as described above, the cancellation fee and/or efforts required from the user for cancellation of the purchased flight ticket, the price, the number of the flight legs, historical rebooking data of a plurality of different users, a ranking of a fare basis within the same flight, an airline rating of the flight and/or seasonality trend(s).

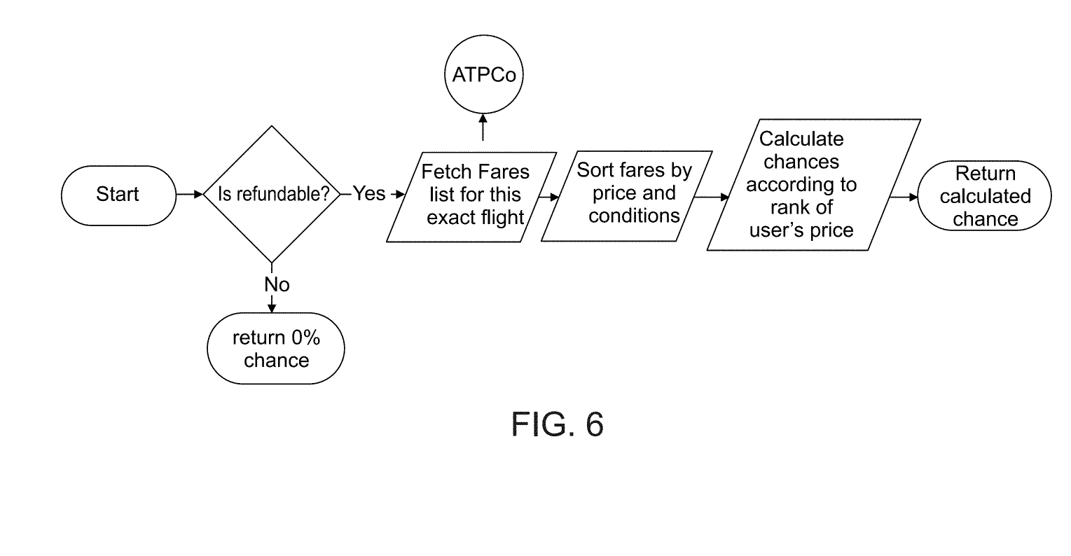

Optionally, both the probability for identifying an alternative flight ticket with a similar value to the purchased flight ticket and probability for identifying an alternative flight ticket with a better value compared to the purchased flight ticket are calculated, for instance see the probability evaluation process depicted in FIG. 6.

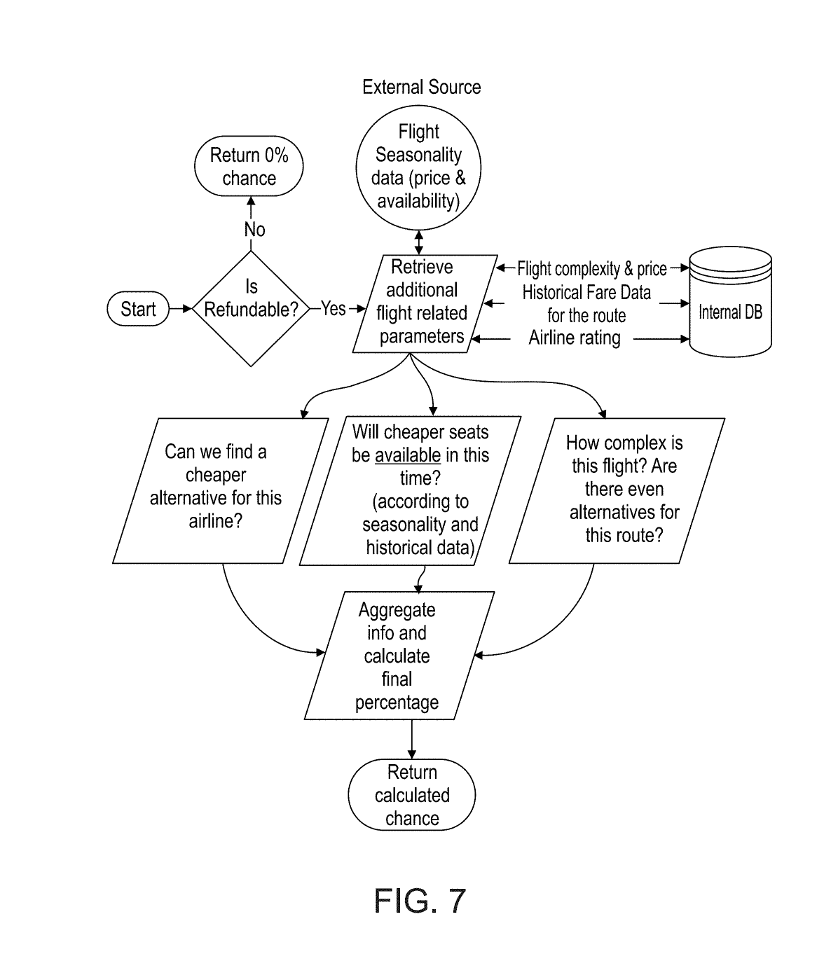

FIG. 7 represents another probability evaluation process. As indicated in the flowchart depicted in FIG. 7 the number of flight legs and/or historical data of seat availability and/or demand for similar flights provided by other airlines are aggregated and taken into account when calculating the probability of finding an alternative flight to the flight of the purchased flight ticket.

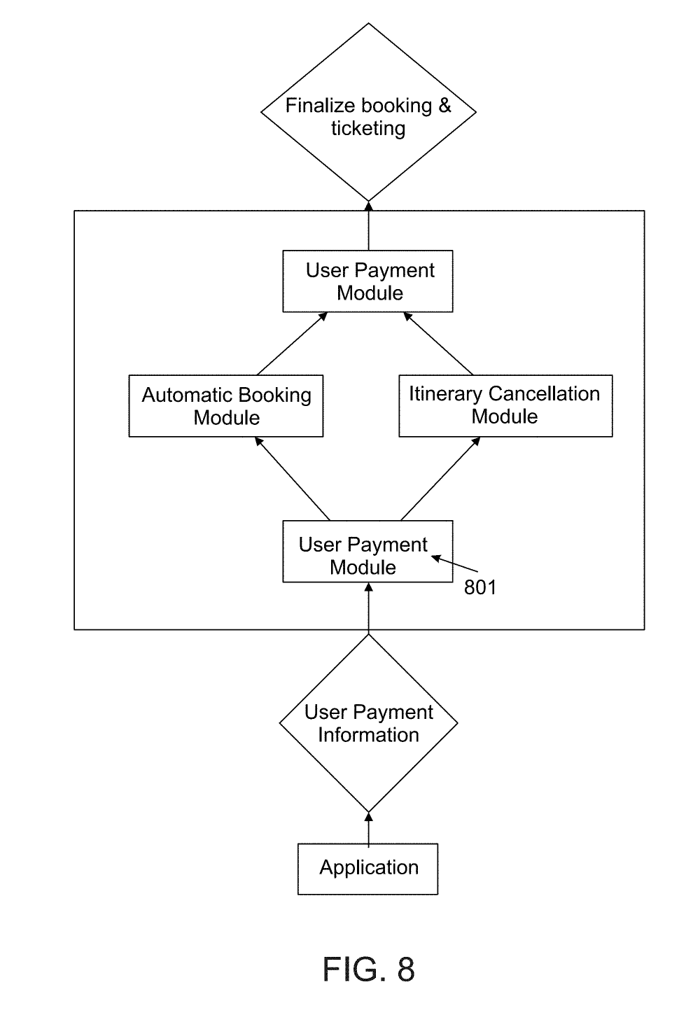

According to some embodiments of the present invention, when a user accepts a rebooking offer provided in a notification sent or presented thereto, a rebooking process that involves both booking an alternative flight ticket and cancelling the purchased flight ticket is initiated, for example see FIG. 8 which depicts a rebooking process according to some embodiments of the present invention. The rebooking process may be initiated by a single selection, for instance a touch or a click. Optionally, when payment information and required passenger details of the user are provided in advance, for example on a registration stage, the process may be completed without further action from the user. The rebooking process orchestrates two sensitive processes in a way that allows for an automated flow with no risk of losing the booking of the alternative flight ticket.

First, as shown at 801, payment confirmation is received and verified by a payment processor module or process. In order to eliminate risk, booking of the alternative flight ticket is made prior to cancellation and/or change of the purchased flight ticket.

A payment processor module responsible for accepting payment approval received via a user application 233, verifying the payment proceeding with the rest of the rebooking process.

Optionally, once a payment is approved for the alternative flight ticket, a booking source is selected, optionally based on service level agreement or cost, and the alternative flight ticket is booked. When a confirmation that the purchased flight ticket is cancelled, the alternative flight ticket is automatically ticketed.

Optionally, a booking source is done based on the country of residence of the user, the country origin of the flight, the currency of purchase, and/or the cost of ticketing. The ticketing process, once cancellation and/or change have been confirmed, incurs charges for the user and finalizes the booking.

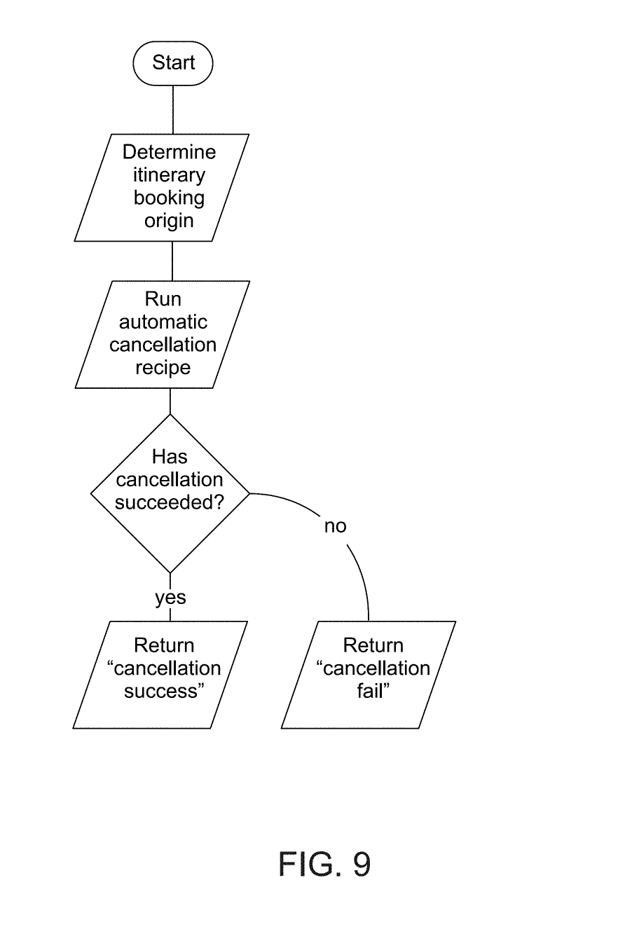

Optionally, a cancellation module is executed to cancel the purchased flight ticket, for instance by identifying a booking source origin, for instance by reading respective ticket parameters which are extracted above, for example by using an optical character recognition (OCR) process or by parsing the ticket data, and performing the cancellation and/or change accordingly. Since each booking provider has a different mechanism for cancelling a flight, records of a database of communication instructions objects such as cancelling sub modules or scripts, referred to also as an automatic cancellation recipe may be reviewed to identify a suitable module for calculation usage. For the cancellation process, the module may utilize a selected application programming interface (API) or browser automation tool in order to execute the cancellation flow. Each cancelling sub module or script includes instructions needed for the respective API or browser automation tool to perform the cancellation. For example FIG. 9 which is a flowchart of a cancellation process, according to some embodiments of the present application.

Optionally cancelling, booking and/or ticketing are performed using a communication instructions object that is designated for communicating with a certain online ticket provider and selected form a set of a plurality of different communication instructions objects each adapted for a different online ticket provider service. The cancellation flow may incur charges for the user in a form of a cancellation fee and/or change fee.

Reference is now made to an exemplary use case of the system from the user point of view. In use, a user registers to a service and a user record is generated and stored in the system 200 for example in DB 203. The user forwards a flight itinerary confirmation email to a specified email address of the system 200. The email includes an indication of a purchased flight ticket from TLV to JFK, stopping through FRA. The flight is business class, refundable with Lufthansa. The price is fairly high for the season, for instance 4500$. The system 202 retrieves the incoming mail and parses it using a parser. Fare Rules (e.g. cancellation fees, change fees) are identified as missing and acquired from a network source for airline fares, for example as described above. When the flight is fully parsed a purchased flight record is stored in database 203 to allow the flight tickets discovery process to iteratively or continuously (referred to interchangeably) be executed for acquiring a match with alternative flight tickets.

Before submitting a query to an external network source 150, the flight tickets discovery process calculates, inter alia based on the price for the flight and the reimbursement cost, a probability of identifying alternative flight tickets with identical or better values. This is done based on historical data analysis, airline rank and the number of flight legs as described above. Now, the client application of the user receives from the system 200 an indication of the probability of finding an alternative flight ticket. The discovery process is optimized according to the probability of finding an alternative flight ticket. In each of the matching iterations, flight search results are ranked and filtered as described above, for instance according to the user's preferences and historical data for the user and similar users. When an alternative flight ticket is found, a notification specifying an offer to purchase the alternative flight ticket is sent to the client, for instance a direct flight from TLV to JFK via El Al airline. Progressive Notification Module decides whether an alternative flight ticket is worthy of notifying to the user. When the matched alternative flight ticket is worthy, a notification is sent via an application push notification and/or email. The user sees the notification and responds by clicking on it and entering an application rendering a GUI allowing the user to rebook a flight and/or to decline the offer, for instance by a press of a button. The user observes the details of the alternative flight ticket offered to him and decides to rebook his flight for this better price and no connection. When the user clicks the rebooking confirmation button, an automatic booking and cancellation process is executed optionally in a synchronous manner as described above, making sure the user does not lose a previous flight ticket and a new booking is successfully purchased and confirmed.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems will be developed and the scope of the term a system, a network, a node, a client and a GUI is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A system of managing a rebooking of a purchased flight ticket by iteratively querying a plurality of network resources using a plurality of software modules for data used for matching an alternative flight ticket, comprising:
a program store storing code; and
a processor coupled to the program store for executing the stored code, the code comprising:
code instructions for designating a purchased flight ticket of a flight comprising a plurality of purchased flight legs;
code instructions for gathering purchased flight data by identifying, for each one of said plurality of purchased flight legs, a plurality of values each of one of a plurality of flight leg parameters comprising at least a price, a flight class, departure time, and arrival time;
code instructions for querying, in each of a plurality of matching iterations, at least one flight leg database for a match indicative of an alternative flight ticket based on said purchased flight data;
code instructions for estimating in each of a plurality of matching iterations, when said match is found, a rebooking advisability score while taking into account a cancellation fee of at least one of said plurality of purchased flight legs; and
code instructions for outputting a notification about said alternative flight ticket when said rebooking advisability score is above a threshold.

2. The system of claim 1, wherein said notification is forwarded in one of said plurality of matching iterations only when respective said alternative flight ticket is estimated to be better than another alternative flight ticket associated with a previously sent notification in a previous matching iteration of said plurality of matching iterations.

3. The system of claim 1, wherein said processor executes additional code instructions in said stored code, the additional code instructions comprising:
code instructions for estimating a current probability of having a future alternative flight ticket which is better than said alternative flight ticket;
wherein said notification is forwarded when said current probability complies with a threshold.

4. The system of claim 1, wherein said processor executes additional code instructions in said stored code, the additional code instructions comprising:
code instructions for estimating a probability a user will cancel said purchased flight ticket for an alternative flight ticket according to an analysis of a member of a group consisting of said cancellation fee, said price, a number of said plurality of flight legs, historical rebooking data of a plurality of different users, a ranking of a fare basis within said flight, an airline rating of said flight at least one seasonality trend;
wherein at least one flight leg database is queried when said probability is higher than a threshold.

5. The system of claim 1, wherein said processor executes additional code instructions in said stored code, the additional code instructions comprising:
code instructions receiving from a response to said notification via said network, said response comprises a rebooking indication;
code instructions for booking said alternative flight ticket;
code instructions for canceling said purchased flight ticket when said alternative flight ticket is booked;
code instructions for ticketing alternative flight ticket.

6. The system of claim 5, wherein said processor executes additional code instructions in said stored code, the additional code instructions comprising:
selecting at least one communication instructions object that comprises instructions for communicating with an online ticket provider service of flight tickets that offers for sale said alternative flight ticket, said at least one communication instructions object is selected from a plurality of communication instructions objects each comprising different instructions for communicating with a different online ticket provider service;
wherein said booking, said canceling, and said ticketing are done using said communication instructions object.

7. The system of claim 1, wherein said processor executes additional code instructions in said stored code, the additional code instructions comprising:
code instructions estimating a rank of said purchased flight ticket according to an analysis of said plurality of values of each of said plurality of flight leg parameters, and
wherein at least one flight leg database is queried when said rank is higher than a threshold.

8. The system of claim 1, wherein said processor executes additional code instructions in said stored code, the additional code instructions comprising:
code instructions estimating a rank of said alternative flight ticket according to an analysis of values of each of said plurality of flight leg parameters of said alternative flight ticket;
wherein said notification is sent to a user when said rank is higher than a threshold.

9. The system of claim 8, wherein said rank is calculated based on a suitability of said alternative flight ticket to a user profile of said user.

10. The system of claim 8, wherein said plurality of values comprises at least some members of a group consisting of an aircraft model, an aircraft, an aircraft version, an airline, a seat type, amenities associated with the flight ticket, a meal evaluation score or type, a luggage cost, a cabin class, a flight duration, a layover time, a number of connections, a mileage point accrual, fare rules, a cancellation fee, a change fee, and airport ranks.

11. The system of claim 1, wherein said notification is sent to a client application executed on a client terminal associated with a user.

12. The system of claim 1, wherein said notification is an email or an SMS sent to a user.

13. The system of claim 1, wherein said processor executes additional code instructions in said stored code, the additional code instructions comprising:
acquiring at least some of said plurality of values from a Global Distribution System by using at least some others of said plurality of values as search query terms.

14. A method of managing a rebooking of a purchased flight ticket by iteratively querying a plurality of network resources using a plurality of software modules for data used for matching an alternative flight ticket, comprising:
designating a purchased flight ticket of a flight comprising a plurality of purchased flight legs;
gathering purchased flight data by identifying, for each one of said plurality of purchased flight legs, a plurality of values each of one of a plurality of flight leg parameters comprising at least a price, a flight class, departure time, and arrival time;
in each of a plurality of matching iterations, querying at least one flight leg database for a match indicative of an alternative flight ticket based on said purchased flight data;
in each of a plurality of matching iterations, when said match is found, estimating a rebooking advisability score while taking into account a cancellation fee of at least one of said plurality of purchased flight legs; and
when said rebooking advisability score is above a threshold forwarding a notification about said alternative flight ticket.

15. A computer program product for managing a rebooking of a purchased flight ticket by iteratively querying a plurality of network resources using a plurality of software modules for data used for matching an alternative flight ticket, the computer program product comprising:
one or more non-transitory computer-readable storage mediums, and program instructions stored on at least one of the one or more storage mediums, the program instructions comprising:
code instructions for designating a purchased flight ticket of a flight comprising a plurality of purchased flight legs;
code instructions for gathering purchased flight data by identifying, for each one of said plurality of purchased flight legs, a plurality of values each of one of a plurality of flight leg parameters comprising at least a price, a flight class, departure time, and arrival time;
code instructions for querying, in each of a plurality of matching iterations, at least one flight leg database for a match indicative of an alternative flight ticket based on said purchased flight data;
code instructions for estimating in each of a plurality of matching iterations, when said match is found, a rebooking advisability score while taking into account a cancellation fee of at least one of said plurality of purchased flight legs; and
code instructions for sending a notification about said alternative flight ticket when said rebooking advisability score is above a threshold.
